(19) United States
(12) Patent Application Publication
(10) Pub. No.: US 2025/0092191 A1
(43) Pub. Date: Mar. 20, 2025

(54) BIO-BASED ANTIMICROBIAL POLYESTER POLYMERS

(71) Applicant: Honeywell International Inc., Charlotte, NC (US)

(72) Inventors: Jian Hou, Shanghai (CN); Junjia Fang, Zhang Jiagang (CN); Hansong Li, Zhang Jiagang (CN); Alex Ciu, Suzhou (CN); Siyue Li, Hong Kong (HK)

(21) Appl. No.: 18/824,064

(22) Filed: Sep. 4, 2024

Related U.S. Application Data
(60) Provisional application No. 63/539,179, filed on Sep. 19, 2023.

(51) Int. Cl. C08G 63/685; A01N 47/44; A01P 1/00

(52) U.S. Cl. CPC C08G 63/6852; A01N 47/44; A01P 1/00

(57) ABSTRACT

A bio-based polyester containing guanidine structures that increased antibacterial rates and the method of making thereof.

### CROSS-REFERENCE TO RELATED APPLICATION

This application claims the benefit under 35 U.S.C. § 119(e) of U.S. Provisional Application No. 63/539,179, filed on Sep. 19, 2023, which is incorporated herein by reference in its entirety.

### FIELD

The present disclosure relates to a polyester containing guanidine structures and the method of making thereof.

### BACKGROUND

Bio-based polymers have emerged as a potential solution for replacing petroleum-based polymeric materials and reducing the dependence on depleting crude oil reserves. Advantageously, many existing bio-based polymers are biodegradable, in particular, natural bio-based polymers, such as polysaccharides and proteins, but also several synthetic biopolymers, such as poly(lactic acid) and PHA. Currently, production of bio-plastics is continuously growing. In some of the uses of bio-based polymers, additional properties are also needed, such as antimicrobial properties for food packaging and biomedical devices, wherein microbial contamination can cause serious problems for public health and safety.

5-Hydroxymethylfurfural (HMF) is a bio-based furan compound. Due to its chemical properties, it is widely used in medicine, chemistry, energy and other fields. Its derivatives have been applied in fields such as fine chemicals, medicine, degradable plastics, and more. For example, the bio-based PEF polyester based on 2,5-furandicarboxylic acid exhibits desirable properties such as gas barrier and biodegradability.

Based on the good broad-spectrum bactericidal effect of guanidine, polymers containing guanidine structure may have a very wide range of uses. Therefore, it is desirable in this field to develop guanidine-containing bio-based polyesters with antibacterial properties of 5-hydroxymethylfurfural as raw materials.

### SUMMARY

The present disclosure provides a polymer of the formula

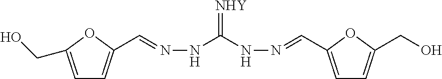

wherein Y is selected from one of HCl, HBr, H₂SO₄, H₂CO₃, H₃PO₄, HNO₃, CH₃COOH, and CH₃(CH₂)₁₆COOH.

The present disclosure further provides a method of synthesizing a polymer containing guanidine structure in the main chain, including reacting a guanidine salt with 5-hydroxymethylfurfural (HMF) to obtain a diol monomer; and reacting the diol monomer with a diol and diacid to obtain the polymer containing guanidine.

### DETAILED DESCRIPTION

The present disclosure provides a bio-based polymer comprising a guanidine group in the backbone of the main chain, as seen in Formula (I):

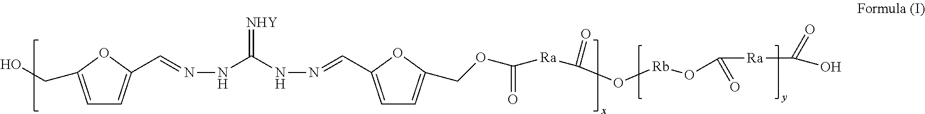

wherein Ra is a linear, branched, cyclic saturated or unsaturated carbon chain containing 2-6 carbon atoms;
Rb is a linear, branched, cyclic saturated or unsaturated carbon chain containing 0-8 carbon atoms; and
Y is HCl, HBr, H₂SO₄, H₂CO₃, H₃PO₄, HNO₃, CH₃COOH, or CH₃(CH₂)₁₆COOH.

The guanidine comprising polymer may exhibit improved long-term antimicrobial ability over known polymers. As used herein, the term “bio-based” refers to a product that is wholly or partially derived from materials of biological origin, excluding materials embedded in geological formations and/or fossilized.

To synthesize the polymer of Formula (I), a two-step reaction may be used. In the first step, a bio-based diol monomer may be formed from the reaction of a guanidine and 5-hydroxymethylfurfural (HMF). In the second step, the bio-based diol monomer may undergo polycondensation with a diol and a diacid to create the polymer of Formula (I).

### A. Step I: Formation of Bio-based Diol Monomer

A guanidine or guanidine salt may undergo a reaction with HMF to create a bio-based diol monomer that comprises guanidine groups of Formula (II):

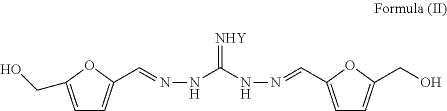

wherein Y is HCl, HBr, H₂SO₄, H₂CO₃, H₃PO₄, HNO₃, CH₃COOH, or CH₃(CH₂)₁₆COOH.

The guanidine may be a salt selected from 1,3-diaminoguanidine hydrochloride, 1,3-diaminoguanidine phosphate, 1,3-diaminoguanidine carbonate, 1,3-diaminoguanidine sulfate, 1, 3-diaminoguanidine bromate, 1,3-diaminoguanidine nitrate, 1,3-diaminoguanidine acetate, 1,3-diaminoguanidine stearate.

5-hydroxymethylfurfural (HMF) is a compound formed by the dehydration of reducing sugars. HMF comprises a furan ring and both aldehyde and alcohol functional groups. HMF has been widely recognized a s a key intermediate in the production of biomass derived fuels and polymers. The aldehyde group of HMF may react with a terminal nitrogen of the guanidine salt to form the diol monomer of Formula (II).

To create the diol monomer of Formula (II), the molar ratio of the moles guanidine salt to moles of HMF may be 0.8, 0.9, 1.0 to 1.1, 1.15, 1.2, or any range using the foregoing values as end points, such as 0.8 to 1.2, 0.9 to 1.15, or 1.0 to 1.10.

The reaction of HMF and the guanidine salt may be comprise a solvent. Suitable solvents may include ethanol, methanol, propanol, butanol, acetone, tetrahydrofuran N,N-dimethylformamide (THR DMF), and dimethyl sulfoxide (DMSO).

The reaction of step I may be carried out at a temperature of 60° C., 70° C., 80° C. to 85° C., 90° C., 100° C., or any range using the foregoing values as endpoints, such as 60-100° C., 70-90° C., or 80-85° C.

The reaction of step I may be carried out for an amount of time from 6 hours, 6.25 hours, 6.5 hours to 7 hours, 7.5 hours, 8 hours, or any range using the foregoing values as endpoints, such as 6-8 hours, 6.25-7.5 hours, or 6.5-7 hours.

Once the bio-based diol monomer is formed, the diol monomer may be filtered out of the solvent and dried before moving onto step II. Drying the diol monomer may be done at a temperature of 40, 50° C., 55° C. to 60° C., 70° C., 80° C., or any range using the foregoing values as endpoints, such as 40-80° C., 50-70° C., or 55-60° C.

Drying the diol monomer may be carried out for an amount of time from 2 hours, 4 hours, 6 hours to 6.5 hours, 8 hours, 10 hours, or any range using the foregoing values as endpoints, such as 2-10 hours, 4-8 hours, or 6-6.5 hours.

### B. Step II: Polycondensation

The bio-based diol monomer may undergo a polycondensation reaction with reaction with a bio-based diol and diacid to form the polymer of Formula (I).

A “diol” refers to a compound having two hydroxyl groups. The hydroxyl groups of the diol may be connected by a bridging group selected from: an alkylene group; an alkenylene group; an alkynylene group; or an arylene group. The polyol may lack acid groups, such as a non-acid containing polyol.

The diol may be of Formula (III):

HO—Rb—OH Formula (III)

wherein Rb is a linear, branched, cyclic saturated or unstaturated carbon chain containing 0-8 carbon atoms.

Suitable diols may include but are not limited to the following: ethylene glycol; 1,2-propane diol; 1,3-propane diol; 1,2-butandiol; 1,3-butandiol; 1,4-butandiol; but-2-ene 1,4-diol; 2,3-butane diol; 2-methyl 1,3-propane diol; 2,2′-dimethyl 1,3-propanediol (neopentyl glycol); 1,5 pentane diol; 3-methyl 1,5-pentanediol; 1,6-hexane diol; 2-ethyl 1,3-hexane diol; diethylene glycol; triethylene glycol; dipropylene glycol; 2,2,4-trimethyl pentane 1,3-diol; 1,4 cyclohexane dimethanol; 2,2,4,4-tetramethyl cyclobutane 1,3-diol; isosorbide; 1,4-cyclohexane diol; and mixtures thereof. Preferred diols may include ethylene glycol, 1,4-butandiol, and 1,6-hexanediol.

The molar ratio of the moles of the bio-based diol monomer of Formula (II) to moles of diol of Formula (III) may be from 0.1, 1, 10, 30 to 60, 70, 80, 90, or any range using the foregoing values as end points, such as 0.1 to 90, 1 to 80, 10 to 70, or 30 to 60.

A diacid may be a dicarboxlic acid of Formula (IV):

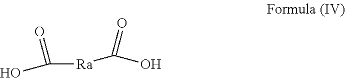

wherein Ra is a linear, branched, cyclic saturated or unsaturated carbon chain containing 2-6 carbon atoms.

Suitable dicarboxylic acids may include, but are not limited to, oxalic acid; malonic acid; succinic acid; glutaric acid, adipic acid; pimelic acid; suberic acid; terephthalic acid; maleic acid; fumaric acid; cyclohexane-1,4-dicarboxylic acid; 2,5-Furandicarboxylic acid; and mixtures thereof. Preferred diacids may include oxalic acid, succinic acid and adipic acid.

The molar ratio of the sum of the moles of the diol monomer of Formula (II) and the moles of the diol of Formula (III) to the moles of the dicarboxylic acid of Formula (IV) may be from 0.8, 0.9, 1.0 to 1.1, 1.15, 1.2, or any range using the foregoing values as end points, such as 0.8 to 1.2, 0.9 to 1.15, or 1.0 to 1.10.

The polycondensation reaction may be carried out in an environment of an inert gas. Suitable inert gas environments may comprise at least one of nitrogen, argon, and helium gas.

The reaction of step II may be carried out at a temperature of 140° C., 145° C., 150° C. to 160° C., 170° C., 180° C., or any range using the foregoing values as endpoints, such as 140-180° C., 145-170° C., or 150-160° C.

The polycondensation reaction of step II may be carried out for an amount of time from 1 hours, 1.5 hours, 2 hours to 2.5 hours, 3 hours, 4 hours, or any range using the foregoing values as endpoints, such as 1-4 hours, 1.5-3 hours, or 2-2.5 hours.

Once the initial reaction time has elapsed, the reaction may be further continued at a reduced pressure of 100 Pa, 200 Pa, 400 Pa to 600 Pa, 800 Pa, 1000 Pa, or any range using the foregoing values as endpoints, such as 100-1000 Pa, 200-800 Pa, or 400-600 Pa, and then continued for an amount of time from 2 hours, 2.5 hours to 3 hours, 4 hours, or any range using the foregoing values as endpoints, such as 2-4 hours, or 2.5-3 hours.

After the reaction is kept at the reduced pressure, the reaction may be further continued at a temperature from 160, 165° C., 170° C. to 180° C., 190° C., 200° C., or any range using the foregoing values as endpoints, such as 160-200° C., 165-190° C., or 170-180° C., for an amount of time from 4 hours, 5 hours, 7 hours to 8 hours, 9 hours, 10 hours, or any range using the foregoing values as endpoints, such as 4-10 hours, 5-9 hours, or 7-8 hours.

The resulting reaction product may be a bio-based polyester polymer comprising a guanidine structure in the main chain of Formula (I).

### III. Properties of Bio-based Polymer

### A. Acid Value

The acid value of a polymer may be determined using a titrator, such as a Metrohm 798 MPT Titrino automatic titrator, manufactured by Metrohm AG, according to GBR-2895-2008.

The bio-based polymer may have an acid value of 60 mg KOH, 70 mg KOH, 80 mg KOH to 90 mg KOH, 95 mg KOH, 100 mg KOH, or any range using the foregoing values as endpoints, such as 60 to 100 mg KOH, 70 to 95 mg KOH, or 80 to 90 mg KOH, as determined according to GBT-2895-2008.

### B. Viscosity

The viscosity of a polymer may be determined using the standard method according to GB/T 1632.1-2008.

The bio-based polymer of the present disclosure may have a viscosity of 0.10 dL/g, 0.15 dL/g, 0.18 dL/g to 0.20 dL/g, 0.25 dL/g, 0.30 dL/g, or any range using the foregoing values as endpoints, such as 0.10-0.30 dL/g, 0.15-0.25 dL/g, or 0.18-0.20 dL/g, as determined according to GB/T 1632.1-2008.

### C. Antibacterial Rate

The ability of a polyester to inhibit or hinder the growth and reproduction of bacteria or fungi may be characterized as antibacterial activity. To measure the antibacterial activity of a polyester a control sample and a test sample may be tested according to GB T/21510-2008.

To prepare the control sample, 0.5 g±0.05 g of a control sample (SiO₂ powder) may be weighed into a flask. To the flask, 95 ml of phosphate buffer containing 0.10% Tween-80 may be added and mixed. Once mixed, 5 mL of prepared bacteria suspension may be added to the flask.

To prepare the test sample, in a separate flask, 0.5 g±0.05 g of a test sample powder may be added along with 95 ml of phosphate buffer containing 0.10% Tween-80 and mixed together. Once mixed, 5 mL of prepared bacteria suspension may be added to the flask.

Both the flask with the control sample and the flask with the test sample may be fixed onto an oscillating bed at a speed of 150 r/min and a temperature of 37° C.±1° C. for 1 to 4 hours.

A nutrient agar medium may be melted at 45-55° C. The melted agar may be poured into two plates.

Following oscillation, 1 ml of the sample solution and control solution may be added to the sterile dishes containing nutrient agar medium. The dishes may be placed in a 37° C.±1° C. incubator for colony count.

The antibacterial rate may be calculated using the Equation (I):

$$R = \frac{A - B}{B} \times 100 \% \qquad Equation ( I )$$

wherein R is the antibacterial rate; A is the average number of bacteria recovered after the control sample was in contact with the test bacteria for a certain period of time; and B is the average number of bacteria recovered after the test sample was in contact with the test bacteria for a certain period of time.

The bio-based polymer of the present disclosure may exhibit an antibacterial rate of 5%, 10%, 15% to 20%, 25%, 30%, or any range using the foregoing values as endpoints, such as 5-30%, 10-25%, or 15-20%, wherein the antibacterial rate is determined using the method described above.

### IV. Application of Bio-based Antimicrobial Polymer

The bio-based antibacterial polymer of the present disclosure may be used in a variety of different applications. The bio-based antibacterial polymer may used in the manufacture of antibacterial fabrics, antibacterial plastic consumables, and the like. Further, the polymer may be used to disinfect surfaces and in the manufacturing of food packaging, biomedical devices, and hand-held water filters. Due to the antimicrobial properties of the polymer, the bio-based antibacterial polymer may be used in the manufacturing of sportswear, women's wear, undergarments, shoes, furnishings, hospital linens, towel and wipes, and aesthetic clothing to impart biostatic properties of the polymer.

### EXAMPLES

Aspects of the present disclosure are further illustrated by reference to the following examples. It will be apparent to those skilled in the art that many modifications, both to materials, and methods, may be practiced without departing from the scope of the disclosure.

### Example 1

### Monomer A Synthesis

This example demonstrates the synthesis of 2,2′-Bis[(3-hydroxyfuran)methylene]carbonimidic dihydrazide hydrochloride.

In a three-necked 500 mL glass flask equipped with a reflux condenser, 1,3-diaminoguanidine monohydrochloride (0.20 mol, 2.5 g) and 5-hydroxymethylfurfural (0.40 mol, 5.04 g) were dissolved in 250 mL of ethanol. The solution was mixed by stirring at 50° C. for 48 hours under a nitrogen atmosphere. The precipitate was then filtered and washed three times with ethanol and ether absolute to remove impurities. Finally, the precipitate was dried at 60° C. at a reduced pressure for 12 hours to obtain 2,2′-Bis[(3-hydroxyfuran)methylene]carbonimidic dihydrazide hydrochloride, monomer A.

### Example 2

### Polyester Synthesis

To synthesis the bio-based polyester, 34.1 g monomer A (0.1 eq), 36 g butanediol (0.4 eq), 59.1 g succinic acid(0.5 eq) was put into a 500 mL reactor, heated to 170° C. in a nitrogen gas environment, and stirred for 2 hours. After the initial 2 hours, the vacuum was reduced to 100 Pa for 2 hours.

After the pre-polycondensation for 4 hours, the temperature was raised to 180° C., and allowed to react for another 8 hours. A bio-based polyester that contains guanidine in the main chain was obtained. The acid value of received polyester was 65 as determined according to GBT-2895-2008. The measured intrinsic viscosity was about 0.22 dl/g as determined using an Ubbelohde viscometer with DMSO as a solvent. The antibacterial rate was 15%.

### Example 3

### Polyester Synthesis

To synthesis the bio-based polyester, 68.2 g monomer A (0.2 eq), 27.2 g butanediol (0.3 eq), 59.1 g succinic acid(0.5 eq) were put into a 500 mL reactor, heated to 170° C. in a nitrogen gas environment, and stirred for 2 hours. After the initial 2 hours, the vacuum was reduced to 100 Pa for 2 hours.

After pre-polycondensation for 4 hours, the temperature was raised to 180° C. and reacted for another 8 hours. A bio-based polyester containing guanidine in the main chain was obtained. The acid value of received polyester was 97 as determined according to GBT-2895-2008. The measured intrinsic viscosity was about 0.16 dl/g as determined using an Ubbelohde viscometer with DMSO as a solvent, and the antibacterial rate was 23%.

Wherein particular examples of this invention have been described above for purposes of illustration, it will be evident to those skilled in the art that numerous variations of the details of the present invention may be made without departing from the invention as defined in the appended claims. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A polymer of the formula: 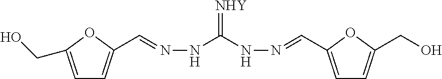
wherein Y is selected from one of HCl, HBr, H₂SO₄, H₂CO₃, H₃PO₄, HNO₃, CH₃COOH, and CH₃(CH₂)₁₆COOH.

2. The bio-based polymer of claim 1, wherein the polymer is formed from chemical components comprising:
a guanidine salt;
5-hydroxymethylfurfural (HMF);
a solvent;
a diol of the formula:
OH—Rb—OH; and
a diacid of the formula:

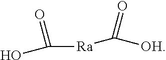

3. The bio-based polymer of claim 2, wherein the guanidine salt is selected from 1,3-diaminoguanidine hydrochloride, 1,3-diaminoguanidine phosphate, 1,3-diaminoguanidinecarbonate, 1,3-diaminoguanidine sulfate, and combinations of the foregoing.

4. The bio-based polymer of claim 2, wherein a ratio of moles of guanidine salt to HMF is from 0.8 to 1.2.

5. The bio-based polymer of claim 2, wherein the solvent is selected from ethanol, methanol, propanol, butanol, acetone, tetrahydrofuran dimethylformamide (THR DMF), dimethyl sulfoxide (DMSO), and combinations of the foregoing.

6. The bio-based polymer of claim 2, wherein the diol is one of ethylene glycol; 1,3-proane diol; 1,3-butandiol; 1,4-butandiol; but-2-ene 1,4-diol, isosorbide; 1,5 pentane diol; 3-methyl 1,5-pentanediol; 1,6-hexane diol.

7. The bio-based polymer of claim 2, wherein the bio-based polymer has an antibacterial rate of 15-25% according to GB T/21510-2008.

8. The bio-based polymer of claim 2, wherein the bio-based polymer has an acid value of 60-100 mg KOH, as determined using a titrator according to GBT-2895-2008.

9. A method of synthesizing a polymer containing guanidine structure in the main chain, comprising:
reacting a guanidine salt with 5-hydroxymethylfurfural (HMF) to obtain a diol monomer; and
reacting the diol monomer with a diol and diacid to obtain the polymer containing guanidine.

10. The method of claim 9, wherein a ratio of moles of guanidine salt to HMF is from 0.8 to 1.2.

11. The method of claim 9, wherein a ratio of moles of the diol monomer to moles of diol is from 0.1 to 90.

12. The method of claim 9, wherein a ratio of a sum of moles of the diol monomer and diol to the diacid is from 0.8 to 1.2.

13. The method of claim 9, wherein reacting the guanidine salt with HFM is carried out at a temperature of 60° C. to 100° C. for an amount of time from 6 to 8 hours.

14. The method of claim 9, further comprising drying the diol monomer at a temperature of 40° C. to 80° C. for 2 to 10 hours.

15. The method of claim 9 wherein reacting the diol monomer with the diol and diacid is carried out at a temperature of 140° C. to 180° C. for 1 to 4 hours.

16. The method of claim 15, further comprising further reacting the diol monomer, diol and diacid at a pressure of 100 Pa to 1000 Pa for 2 to 4 hours.

17. The method of claim 16, further comprising further reacting the diol monomer, diol, and diacid at a temperature of 160° C. to 200° C. for 4 to 10 hours.
